(19) United States
(12) Patent Application Publication
(10) Pub. No.: US 2018/0099848 A1
(43) Pub. Date: Apr. 12, 2018

(54) CORK EXTRACTING APPARATUS AND METHOD

(71) Applicant: Miles CARLSON, Minneapolis, MN (US)

(72) Inventor: Miles CARLSON, Minneapolis, MN (US)

(21) Appl. No.: 15/289,695

(22) Filed: Oct. 10, 2016

(51) Int. Cl. B67B 7/06

(52) U.S. Cl. CPC B67B 7/063

(57) ABSTRACT

The exemplary cork extracting apparatus may include a body portion and one of more prongs extending from the body portion. The body portion may define an insertion stop surface such that the one or more prongs may be inserted into a cork of a bottle with the insertion stop surface proximate the bottle. Each of the one or more prongs may extend along a prong axis and each prong axis may intersect the insertion stop surface to define an acute angle. The body portion may be configured to be grasped, rotated, and pulled away from the bottle, after the one or more prongs are inserted into the cork, to extract the cork from the bottle.

The present disclosure relates generally to apparatus for extracting corks from bottles and methods of doing the same.

Bottles are typically used for the storage and transportation of fluids. Corks are often used to provide a gas and/or liquid impermeable seal such that the contents of the bottle are preserved against the elements (e.g., bacterial or fungal contamination, oxidation, etc.). Cork screws may be used to remove the cork once the contents of the bottle are needed by a user. However, existing cork screws may tend to be large and bulky. Additionally, cork screws may not be easily carried in a pocket or purse. Cork screws are typically used by twisting the cork screw into the cork disposed within a neck of a bottle and then pulling the cork screw, along with the cork, away from the bottle to remove the cork.

### SUMMARY

Exemplary cork extracting apparatus are described herein. The exemplary cork extracting apparatus may be used to remove a cork (e.g. a cylindrical cork) from a bore of a bottle. In other words, the exemplary cork extracting apparatus may be used to assist in the removal of the cork from a bottle in order to open the bottle (e.g., to access the contents inside the bottle).

An exemplary apparatus for extracting a cork from a bore of a bottle may include a body portion and one or more prongs. The body portion may define an insertion stop surface and one or more grasping features configured to be grasped by a user. The one or more prongs may be coupled to the body portion. Each of the one or more prongs may extend along a prong axis away from the insertion stop surface of the body portion such that the prong axis and the insertion stop surface define an acute angle. The one or more prongs may be configured to be inserted into the cork by the user such that at least a portion of the insertion stop surface may be located proximate the cork, and upon insertion, rotation and movement of the body portion away from the bottle by the user may extract the cork from the bore of the bottle.

In one or more embodiments, the prong axis and the insertion stop surface may define an acute angle between 30 degrees and 60 degrees. In one or more embodiments, the body portion may extend from a first end region to a second end region and the one or more prongs may be coupled to the body portion between the first end region and the second end region. The insertion stop surface of the body portion may be configured to contact the bottle proximate the first end region upon insertion of the one or more prongs into the cork. In one or more embodiments, the one or more prongs may include a first prong and a second prong. The prong axis of the first prong may extend parallel the prong axis of the second prong. In one or more embodiments, the second prong may be farther from the insertion stop surface than the first prong. In one or more embodiments, the first and second prongs may be located at least 1 millimeter from each other.

In one or more embodiments, the exemplary apparatus may define a first surface and a second surface. The first surface may extend perpendicular from the insertion stop surface. The second surface may extend perpendicular from the insertion stop surface and parallel the first surface. The apparatus may also define a thickness of about 2 millimeters between the first surface and the second surface. In one or more embodiments, the one or more grasping features may include a finger aperture configured to receive a finger of the user. In one or more embodiments, the body portion may be configured to rotate about a cork axis of the cork to extract the cork from the bore of the bottle. The one or more grasping features may include a finger aperture configured to receive a finger of the user and a centerpoint of the finger aperture may be offset from the cork axis.

In one or more embodiments, the one or more prongs may include a support between the one or more prongs. The support may extend between a first support edge and a second support edge that is closer to the body portion than the first support edge. A thickness of the support may taper down from the second support edge to the first support edge. In one or more embodiments, the one or more prongs may include one or more protrusions extending from the one or more prongs. In one or more embodiments, each of the one or more prongs may extend from a proximal end coupled to the body portion to a distal end configured to be located proximate an inner wall of the bore of the bottle upon insertion of the one or more prongs.

Another exemplary apparatus for extracting a cork from a bore of a bottle may include a first prong, a second prong, and a body portion. The first prong may extend from a proximal end to a distal end. The second prong may extend from a proximal end to a distal end. The first and second prongs may be configured to be inserted into the cork by a user such that at least one of the distal ends of the first and second prongs may be located proximate an inner wall of the bore of the bottle. The body portion may be coupled to the proximal ends of the first and second prongs and upon insertion of the first and second prongs into the cork, the body portion may be configured to be grasped, rotated, and pulled away from the bottle by the user to extract the cork from the bore of the bottle.

In one or more embodiments, the body portion may define an insertion stop surface configured such that at least a portion of the insertion stop surface may be located proximate the cork when the first and second prongs are inserted into the cork. In one or more embodiments, the proximal ends of the first and second prongs may be coupled to the insertion stop surface of the body portion. The first prong may extend along a first prong axis from the proximal end to the distal end such that the first prong axis and the insertion stop surface may define a first acute angle. The second prong may extend along a second prong axis from the proximal end to the distal end such that the second prong axis and the insertion stop surface may define a second acute angle.

In one or more embodiments, at least one of the first acute angle and second acute angle may be between 30 degrees and 60 degrees. In one or more embodiments, the first acute angle and the second acute angle may be substantially equal. In one or more embodiments, the first and second prongs may be located at least 1 millimeter from each other. In one or more embodiments, the body portion, the first prong, and the second prong may lie in a plane.

Yet another exemplary apparatus for extracting a cork from a bore of a bottle may include a first prong, a second prong, a support, one or more protrusions, and a body portion. The first prong may extend from a proximal end to a distal end and the second prong may extend from a proximal end to a distal end. The first and second prongs may be configured to be inserted into the cork by a user such that at least one of the distal ends of the first and second prongs may be located proximate an inner wall of the bore of the bottle. The support may be between the first and second prongs. One or more protrusions may extend from at least one of the first and second prongs. The body portion may be coupled to the proximal ends of the first and second prongs and may define a finger aperture configured to receive a finger of the user. The body portion may be configured to rotate about a cork axis of the cork to extract the cork from the bore of the bottle and a centerpoint of the finger aperture may be offset from the cork axis. Upon insertion of the first and second prongs into the cork, the body portion may be configured to be grasped, rotated, and pulled away from the bottle by the user to extract the cork from the bore of the bottle.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1 is a perspective cross-sectional view of an exemplary cork extracting apparatus inserted into a cork located in a bore of a bottle.

FIG. 2A is a side elevation view of an exemplary cork extracting apparatus.

FIG. 2B is a top plan view of the exemplary cork extracting apparatus of FIG. 2A.

FIG. 3 is a side cross-sectional view of the exemplary cork extracting apparatus inserted into the cork located in the bore of the bottle as illustrated in FIG. 1.

FIG. 4A is a perspective view of an exemplary cork extracting apparatus inserted into a cork located in a bore of a bottle.

FIG. 4B is a perspective view of the exemplary cork extracting apparatus of FIG. 4A inserted into the cork that has been twisted and pulled away from the bottle.

FIG. 4C is a perspective view of the exemplary cork extracting apparatus of FIG. 4B inserted into the cork that has been further twisted and pulled away from the bottle.

FIG. 4D is a perspective view of the exemplary cork extracting apparatus of FIG. 4C inserted into the cork and depicting the cork extracted from the bore of the bottle.

FIG. 5 is a side elevation view of another exemplary cork extracting apparatus.

### DETAILED DESCRIPTION

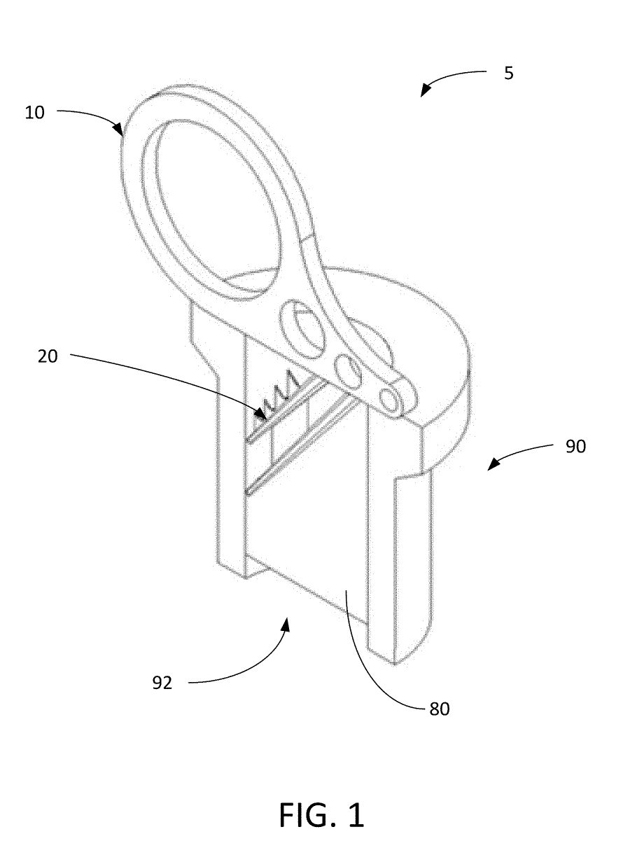

Exemplary methods, apparatus, and systems shall be described with reference to FIGS. 1-5. It will be apparent to one skilled in the art that elements or processes from one embodiment may be used in combination with elements or processes of the other embodiments, and that the possible embodiments of such methods, apparatus, and systems using combinations of features set forth herein is not limited to the specific embodiments shown in the Figures and/or described herein. Further, it will be recognized that the embodiments described herein may include many elements that are not necessarily shown to scale. Still further, it will be recognized that timing of the processes and the size and shape of various elements herein may be modified but still fall within the scope of the present disclosure, although certain timings, one or more shapes and/or sizes, or types of elements, may be advantageous over others.

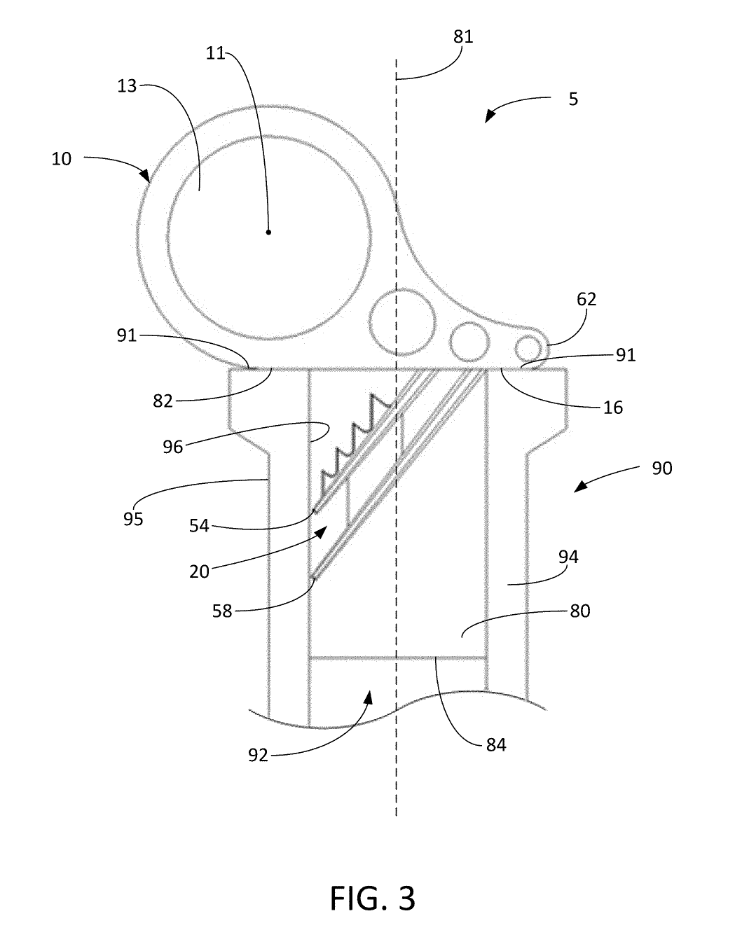

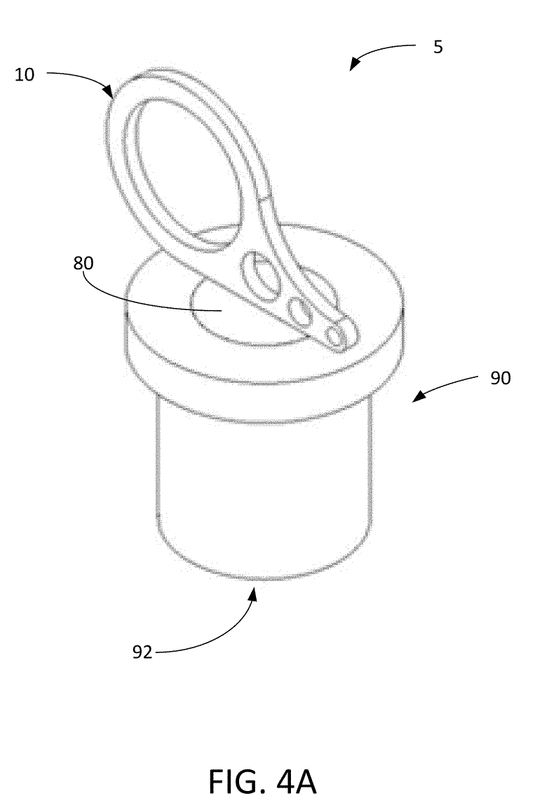

Exemplary cork extracting apparatus 5 may be described in combination with a bottle 90. The bottle 90 may be any size, shape, or dimension. An exemplary bottle 90 as depicted in FIG. 1 may have a cylindrical shape and may include a neck 94 proximate an opening of the bottle 90. The neck 94 may define an outer wall 95 facing the external environment and an inner wall 96 of the bottle 90, opposite the outer wall 95 (e.g., as shown in FIG. 3). The inner wall 96 may define a bore 92 of the bottle 90 proximate the neck 94 and forming the opening through which an interior of the bottle 90 may be accessed. The bore 92 may have a diameter such that a cork 80 may be lodged in the bore 92 of the bottle 90 to, e.g., preserve the contents of the bottle 90. The cork 80 may be a variety of different shapes and sizes to be positioned within the bore 92 through an interference fit. For example, the cork 80 may define a circular, hexagonal, octagonal, or any other suitable cross-sectional shape and, in one or more embodiments, the cork 80 may be cylindrical. Additionally, the center of the cork 80 may define a cork axis 81 as depicted in FIG. 3.

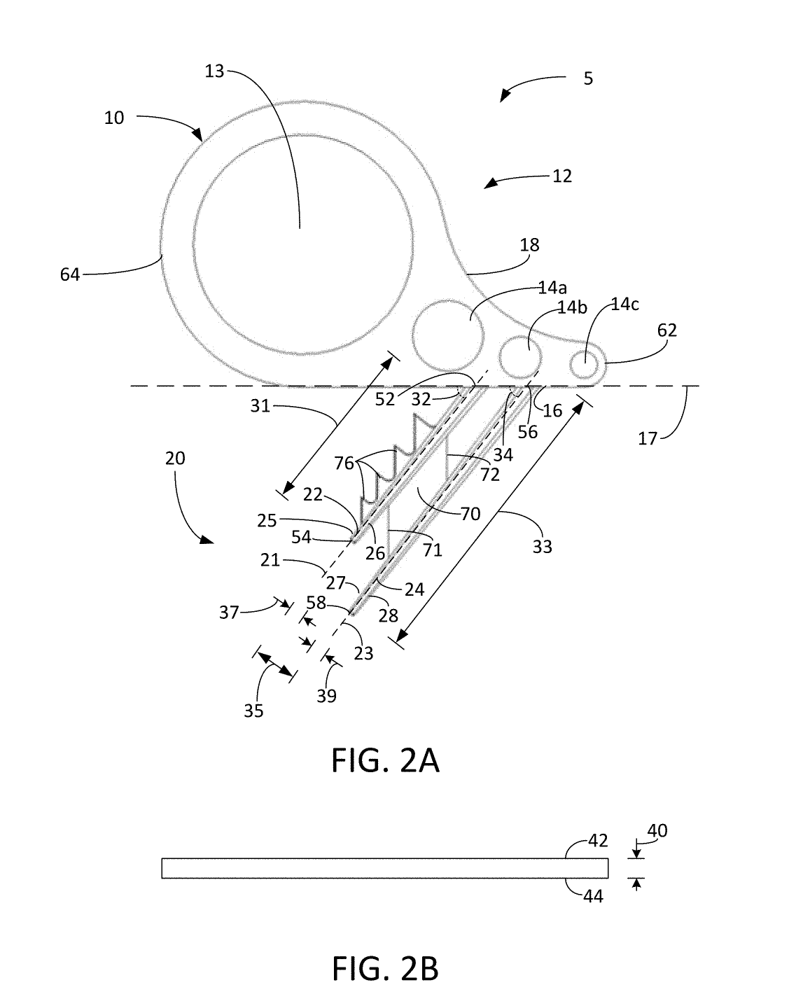

One exemplary cork extracting apparatus 5 that may be used to remove the cork 80 from the bore 92 of the bottle 90 is depicted in FIGS. 1-4. The exemplary cork apparatus 5 may define any size, shape, or configuration suitable to remove the cork 80 from the bore 92 of the bottle 90 as further described herein. As shown in FIG. 1, the cork extracting apparatus 5 may include a body portion 10 and one or more prongs 20 that extend from the body portion 10. Specifically, the one or more prongs 20 may extend from the body portion 10 at one or more locations (e.g., a first prong 22 and a second prong 24 as shown in FIG. 2A). It is noted that FIG. 1 depicts a cross-section of the bottle 90 and cork 80 to better illustrate the interaction between the cork extracting apparatus 5 and the cork 80.

The one or more prongs 20 of the cork extracting apparatus 5 may be configured to be inserted into the cork 80 by a user as will be described further herein. For example, the cork extracting apparatus 5 may be positioned such that the one or more prongs 20 are inserted into the cork 80 that is located in the bore 92 of the bottle 90. The cork 80 may be any suitable cork 80 that is positioned (e.g., lodged) within a bore 92 (e.g., an opening). After inserting the one or more prongs 20 into the cork 80, the body portion 10 may be forced (e.g., pulled, twisted, pushed, etc.) away from the bore 92 to extract the cork 80 from the bore 92 as will be described further herein. In other words, a user may apply a force to the cork extracting apparatus 5 once it has been inserted into the cork 80 located in the bore 92 of the bottle 90 such that the cork 80 may be removed from the bore 92 of the bottle 90.

A side elevation view of an exemplary cork extracting apparatus 5 is illustrated in FIG. 2A and a top view of the exemplary cork extracting apparatus 5 is illustrated in FIG. 2B. The body portion 10 of the cork extracting apparatus 5 may be any shape, size, or configuration such that the body portion 10 may be used to manipulate the cork extracting apparatus 5 to remove the cork 80 from the bore 92 of the bottle 90. For example, the body portion 10 may be configured such that a user can grab, or grasp, the body portion 10 to insert the one or more prongs 20 into a cork 80 as will be further described herein. Further, the body portion 10 may also be configured such that, after inserting one of more prongs 20 into the cork 80, a user can twist, or apply a rotational force, to the cork extracting apparatus 5 while pulling away from the bottle 90 to remove a cork 80 from the bore 92 of the bottle 90.

The body portion 10 may extend from a first end region 62 to a second end region 64. The body portion 10 may take any shape or form therebetween. For example, in the embodiments depicting the body portion 10, the body portion 10 may define an insertion stop surface 16 that extends between the first and second end regions 62, 64. The insertion stop surface 16 may allow insertion of the cork extracting apparatus 5 (e.g., the one or more prongs 20) to a particular depth within the cork 80 and inhibit the insertion of the body portion 10 into the cork 80 which may leave the insertion stop surface 16 proximate to the cork 80. Further, the insertion stop surface 16 may extend along a plane 17 for at least a portion between the first and second end regions 62, 64. In other words, the insertion stop surface 16 may define a flat planar surface (e.g., that extends along plane 17) for at least a portion of the body portion 10 between the first and second end regions 62, 64. The insertion stop surface 16 may contact the bottle 90 proximate either or both of the first and second end regions 62, 64. In one or more embodiments, the insertion stop surface 16 may be flat to provide a stable surface by which the insertion stop surface 16 contacts the bottle 90.

In one or more embodiments, the body portion 10 may include or define one or more grasping features 12 that may be configured to be grasped by a user (e.g., to assist in maneuvering the body portion 10). Specifically, the one or more grasping features 12 defined by the body portion 10 may include, for example, an aperture, an indentation, a handle, a curvature, etc. As shown in FIG. 2A, the body portion 10 defines a variety of one or more grasping features 12 such as, e.g., a finger aperture 13, finger indentation 18, and one or more apertures 14a, 14b, and 14c.

The finger aperture 13 defined by the body portion 10 may be configured to accommodate a finger and allow a user to grasp the body portion 10. For example, the finger aperture 13 may be used for controlling and/or applying force to the cork extracting apparatus 5 (e.g., inserting the one or more prongs 20 into the cork 80, removing the cork 80 by twisting and pulling the cork extracting apparatus 5 away from the bore 92 of the bottle 90, etc.). The shape of the finger aperture 13 may be any suitable shape such that a finger may be positioned within the finger aperture 13. For example, the finger aperture 13 may be a circle, an oval, a square, a rectangle, a hexagon, an octagon, or any other suitable shape. In one or more embodiments, the finger aperture 13 may be configured to be utilized for purposes other than the insertion of a finger to, e.g., maneuver the cork extracting apparatus 5. For example, the body portion 10 may be attached to something through the finger aperture 13, a hexagonally shaped finger aperture 13 may be used to tighten or loosen hexagonally shaped nuts, bolts, screws, etc., the body portion 10 may be used as a cutting tool for foil, the body portion 10 may be used as a screwdriver, the finger aperture 13 may be used with a springed clip for a belt loop, the finger aperture 13 may be used as a bottle opener, etc.

The finger indentation 18 defined by the body portion 10 may be configured to provide positioning of a finger of a user. In other words, the finger indentation 18 may contour to a finger or portion of a hand of a user. For example, when a user inserts a finger into the finger aperture 13, the finger indentation 18 may be positioned and contoured such that an additional finger (e.g., an adjacent finger) may naturally lie within the finger indentation 18 and adjacent to a surface of the finger indentation 18. The finger indentation 18 may be located on either side of the finger aperture 13 (e.g., between the finger aperture 13 and the first end region 62 of the body portion 10 or between the finger aperture 13 and the second end region 64 of the body portion 10). In some embodiments, the body portion 10 may define a finger indentation 18 on multiple sides of the finger aperture 13 (e.g., on opposing sides of the finger aperture 13). The finger indentation 18 may define any shape that is suitable for providing space and positioning for a finger or any other portion of a user's hand.

As shown in FIG. 2A, and discussed herein, the body portion 10 may also include one or more apertures 14a, 14b, and 14c. The one or more apertures 14a, 14b, and 14c may provide locations in addition to the finger aperture 13 that a user may use to grasp, utilize, and/or attach the cork extracting apparatus 5. For example, the body portion 10 may be attached to a keychain, article of clothing, about a person's body, an article of jewelry (e.g., a bracelet or necklace), or any other suitable item through any of the finger aperture 13 and/or the one or more apertures 14a, 14b, 14c (to, e.g., allow quick access to the cork extracting apparatus 5). Specifically, the body portion 10 (e.g., through the finger aperture 13 and/or the one or more apertures 14a, 14b, 14c) may be attached to something such that a user may easily transport the cork extracting apparatus 5. For example, a user may attach the body portion 10 to a key ring so that the cork extracting apparatus 5 may be carried along with keys in a pocket or purse. The body portion 10 may be attached to something through the finger aperture 13 and/or the one or more apertures 14a, 14b, 14c using, e.g., string, cord, thread, clasp, etc. that may be of a fixed length or a variable length. A variable length attachment to the body portion 10 may allow the cork extracting apparatus 5 to provide a longer length of, e.g., string, cord, thread, clasp, etc., when in use and a shorter length (i.e., retracted) when not in use.

The one or more apertures 14a, 14b, 14c may be defined anywhere on the body portion 10. As shown in FIG. 2A, the one or more apertures 14a, 14b, 14c are positioned between the finger aperture 13 and the first end region 62 of the body portion 10. The one or more apertures 14a, 14b, 14c may define any suitable shape. For example, the shape defined by the one or more apertures 14a, 14b, 14c may include a circle, an oval, a square, a rectangle, a hexagon, an octagon, or any other suitable shape.

The cork extracting apparatus 5 may also include one or more prongs 20 that are coupled to or extend from the body portion 10. As discussed herein, the one or more prongs 20 may be configured to be inserted into a cork 80 by a user. Upon insertion of the one or more prongs 20, and rotation and movement of the body portion 10 (connected to the one or more prongs 20) away from the bottle 90, the cork 80 may be extracted from a bore 92 of the bottle 90. The one or more prongs 20 may extend from the body portion 10 in a variety of different locations. For example, the one or more prongs 20 may be positioned in any configuration that is suitable for insertion into the cork 80 and assistance in removal of the cork 80. Specifically, as shown in FIG. 2A, the one or more prongs 20 extend from the body portion 10 between the first end region 62 and the second end region 64. More specifically, the one or more prongs 20 may extend from the insertion stop surface 16 of the body portion 10.

Additionally, the one or more prongs 20 may extend from the body portion 10 in a direction from the first end region 62 to the second end region 64, from the second end region 64 to the first end region 62, or a combination of both. In one or more embodiments, the one or more prongs 20 may extend from the body portion 10 at the first end region 62, at the second end region 64, or somewhere therebetween. In an embodiment in which the one or more prongs 20 extend from the body portion between the first and second end regions 62, 64, it may be described that the insertion stop surface 16 is located on either side of the one or more prongs 20.

In one or more embodiments, the one or more prongs 20 may extend along a prong axis away from the body portion 10. Any of the one or more prongs 20 may extend from the body portion 10 parallel to one another or, in some embodiments, at least one prong of the one or more prongs 20 may not be parallel with another prong of the one or more prongs 20. In one or more embodiments, each of the one or more prongs 20 may extend parallel to each other. In one or more embodiments, the one or more prongs 20 may be positioned such that each of the one or more prongs 20 converges towards each other as the one or more prongs 20 extend farther from the body portion 10. In other words, the one or more prongs 20 may be described as extending along axes that converge to a point.

The one or more prongs 20 may include any number of prongs suitable for extracting a cork 80 from a bore 92 of a bottle 90. For example, as shown in FIG. 2A, the one or more prongs 20 include a first prong 22 and a second prong 24. Each of the first and second prongs 22, 24 may be described as extending between a proximal end (adjacent the body portion 10) and a distal end (away from the body portion 10). For example, the first prong 22 may be described as extending between a proximal end 52 and a distal end 54, and the second prong 24 may be described as extending between a proximal end 56 and a distal end 58. In one or more embodiments, the distal ends 54, 58 of the first and second prongs 22, 24 may be described as tapered or sharp. The tapered or sharp distal ends 54, 58 may be used to facilitate insertion of the first and second prongs 22, 24 into the cork 80 by reducing the insertion resistance.

Each of the first and second prongs 22, 24 may extend between a respective proximal end 52, 56 and a respective distal end 54, 58 along a prong axis. For example, the first prong 22 may extend along a first prong axis 21 and the second prong 24 may extend along a second prong axis 23. A prong distance 35 between the first and second prongs 22, 24 may be measured between the first and second prong axes 21, 23. In other embodiments, the prong distance 35 may be measured between adjacent sides of the first and second prongs 22, 24. In one or more embodiments, the prong distance 35 between the first and second prong axes 21, 23 may be substantially the same for the entire length of the first and second prongs 22, 24 because, e.g., the first and second prongs 22, 24, and prong axes 21, 23, are substantially parallel. In other embodiments, the prong distance 35 between the first and second prong axes 21, 23 may vary along the length of the first and second prongs 22, 24. The prong distance 35 between the first prong axis 21 and the second prong axis 23 may be between about 0.25 cm and about 2 cm. In some embodiments, the prong distance 35 between the first prong axis 21 and the second prong axis 23 may be at least 0.25 cm. In some embodiments, the prong distance 35 between the first prong axis 21 and the second prong axis 23 may be about, e.g., greater than or equal to 0.25 millimeters, greater than or equal to 0.5 millimeters, greater than or equal to 1 millimeter, greater than or equal to 4 millimeters, etc. and/or less than or equal to 13 millimeters, less than or equal to 10 millimeters, less than or equal to 6 millimeters, less than or equal to 3 millimeters, etc.

In one or more embodiments, each of the prong axes 21, 23 may be described as intersecting the insertion stop surface 16 (e.g., the plane 17 extending along at least a portion of the insertion stop surface 16) to define an acute angle. In other words, an angle may be defined between each of the prong axes 21, 23, and the plane 17 of the insertion stop surface 16. For example, an intersection of the first prong axis 21 and the insertion stop surface 16 may define a first acute angle 32 (e.g., measured on the side proximate the second end region 64 of body portion 10) and an intersection of the second prong axis 23 and the insertion stop surface 16 may define a second acute angle 34 (e.g., measured on the side proximate the second end region 64 of the body portion 10). In one of more embodiments, the first and second acute angles 32, 34 may be substantially equal such that the first prong axis 21 and the second prong axis 23 are substantially parallel. In other embodiments, the first and second acute angles 32, 34 may not be equal such that the first and second prong axes 21, 23 are converging or diverging.

Each of the first and second acute angles 32, 34 may define a variety of different angles between the first prong axis 21 and the insertion stop surface 16 and between the second prong axis 23 and the insertion stop surface 16. For example, the first acute angle 32 and/or the second acute angle 34 may be less than or equal to 90 degrees, less than or equal to 75 degrees, less than or equal to 60 degrees, less than or equal to 50 degrees, less than or equal to 40 degrees, etc. and/or greater than or equal to 5 degrees, greater than or equal to 15 degrees, greater than or equal to 30 degrees, greater than or equal to 45 degrees, greater than or equal to 55 degrees, etc. Specifically, the first and second acute angles 32, 34 may define a 45 degree angle.

This angle of one or both of the first and second acute angles 32, 34 may assist in inserting the cork extracting apparatus 5 into the cork 80 with more ease. Additionally, the first and second acute angles 32, 34 may help to provide sufficient grip (e.g., purchase) of the one or more prongs 20 within the cork 80 such that the cork extracting apparatus 5 may remove the cork 80 upon twisting and pulling away from the bottle 90 as opposed to the cork extracting apparatus 5 sliding out from the cork 80 without removal of the cork 80 from the bore 92. In other words, the first and second acute angle 32, 34 may provide some leverage during extraction of the cork 80 because the first and second prong axes 21, 23 are at an angle to the direction by which the cork 80 may move relative to, and be pulled from, the bore 92 (e.g., along the cork axis 81 as shown in FIG. 3). In other words, the angle of the one or more prongs 20 may allow a force to be applied against the cork 80 to extract the cork 80 from the bottle. In one or more embodiments, one of the first and second acute angles 32, 34 may be larger than the other of the first and second acute angles 32, 34 to help increase the grip of the one or more prongs 20 within the cork 80.

The first and second prongs 22 and 24 may be a variety of different lengths. For example, the first prong 22 may define a first prong length 31 along the first prong axis 21 and the second prong 24 may define a second prong length 33 along the second prong axis 23. In one or more embodiment, the second prong 24 may extend farther from the body portion 10 than the first prong 22. In other embodiments, the first prong 22 may extend farther from the body portion 10 than the second prong 24. As shown in FIG. 3, the second prong 24 extends farther from the body portion 10 than the first prong 22 such that both of the first and second prongs 22, 24 are proximate an inner wall 96 (e.g., along a vertical axis) of the bore 92 of the bottle 90 when the one or more prongs 20 are inserted into the cork 80 in the bore 92 of the bottle 90. In yet other embodiments, the first prong 22 and the second prong 24 may extend from the body portion 10 a substantially equal distance. The first prong 22 and/or the second prong 24 may be described as extending from the body portion 10 a distance of about, e.g., greater than or equal to 10 millimeters, greater than or equal to 15 millimeters, greater than or equal to 20 millimeters, greater than or equal to 25 millimeters, etc. and/or less than or equal to 40 millimeters, less than or equal to 35 millimeters, less than or equal to 30 millimeters, less than or equal to 23 millimeters, etc. Specifically, the first prong 22 and/or the second prong 24 may be described as extending from the body portion 10 a distance of about, e.g., 25 millimeters.

The one or more prongs 20 may define a first side, facing the body portion 10, and a second side, facing away from the body portion 10. For example, the first prong 22 may define a first side 25 facing the body portion 10 and a second side 26 opposing the first side 25 of the first prong 22. The second prong 24 may define a first side 27 facing the body portion 10 (and, e.g., facing the second side 26 of the first prong 22) and a second side 28 opposing the first side 27 of the second prong 24. In some embodiments, the prong distance 35 between the first and second prongs 22, 24 may be measured between the sides of the first and second prongs 22, 24 (e.g., between the second side 26 of the first prong 22 and the first side 27 of the second prong 24). Each of the one or more prongs 20 may define a width between the first side and the second side, e.g., measured perpendicular to each of the first and second sides. Each of the one or more prongs 20 may have the same width as one another or different widths. For example, the cork extracting apparatus 5 depicted in FIG. 2A illustrates the first prong 22 defining a first prong width 37 between the first side 25 of the first prong 22 and the second side 26 of the first prong 22 and the second prong 24 defining a second prong width 39 between the first side 27 of the second prong 24 and the second side 28 of the second prong 24. The first prong width 37 and/or the second prong width 39 may be, e.g., greater than or equal to 0.5 millimeters, greater than or equal to 1 millimeter, greater than or equal to 1.5 millimeters, greater than or equal to 2 millimeters, etc. and/or less than or equal to 5 millimeters, less than or equal to 3 millimeters, less than or equal to 2 millimeters, less than or equal to 1.25 millimeters, etc. Specifically, first prong width 37 and/or the second prong width 39 may be about, e.g., 1 to 3 millimeters.

In one or more embodiments, the one or more prongs 20 may define a width that is substantially the same along the entire length of the one or more prongs 20. In other embodiments, the one or more prongs 20 may define a width that varies along the length of the one or more prongs 20. For example, the width of the one or more prongs 20 may be greater at the end proximate the body portion 10 (e.g., the proximal ends 52, 56) than at the opposite ends (e.g., the distal ends 54, 58) of the one or more prongs 20. In other words, the one or more prongs 20 may be described as being tapered. In one or more embodiments, the varying width or taper of the one or more prongs 20 may occur at any location along the one or more prongs 20 and the tapered portion of the one or more prongs 20 may extend for a variety of different lengths of the one or more prongs 20. As shown in FIG. 2A, the tapered portion of the first and second prongs 22, 24 is proximate the distal ends 54, 58.

In one or more embodiments (not shown), the body portion 10 may be configured to allow the one or more prongs 20 to recess or fold into the body portion 10 so a user may transport and store the cork extracting apparatus 5 in a compact manner. For example, the one or more prongs 20 may be hinged or rotated relative to the body portion 10 such that the one or more prongs 20 recess or fold into the body portion 10. In one or more embodiments, the body portion 10 may be configured as a part of another device that includes multiple tools, for example, any other suitable tool, such as a cutting tool, a screwdriver, pliers, etc. In other words, the cork extracting apparatus 5 may be one tool among one or more tools configured together in a single device. The cutting tool may be used to, e.g., remove a foil wrapper that may cover the top of the bottle 90. After removing the foil wrapper, the cork 80 may be exposed such that the cork extracting apparatus 5 may be utilized to extract the cork 80 from the bore 92 of the bottle 90. Furthermore, the cutting tool, screwdriver, pliers, etc. may be used for any other common mechanical use that these tools have been employed for. In one or more embodiments, the one or more prongs 20 described herein may be attached to any device such that the one or more prongs 20 may be rotated relative to the device and configured into a position to be inserted into a cork 80 as described herein.

The one or more prongs 20 may also include a support 70 between the one or more prongs 20 to add support and rigidity to the one or more prongs 20. Additionally, the support 70 may provide more surface area to which a force may be applied when twisting the cork extracting apparatus 5 to extract a cork 80. The support 70 may extend between the second side 26 of the first prong 22 and the first side 27 of the second prong 24. In one or more embodiments, the one or more prongs 20 may include more than one support 70. The support 70 may extend from a first support edge 71 to a second support edge 72, with the first support edge 71 being farther from the body portion 10 than the second support edge 72. The support 70 may be various different lengths along the length of the one or more prongs 20. For example, the support 70 may extend any length between the proximal and distal ends 52, 56, 54, 58 of the one or more prongs 20. Specifically, the first support edge 71 may be proximate the distal ends 54, 58 or the first support edge 71 may be between the proximal ends 52, 56 and the distal ends 54, 58 and the second support edge 72 may be proximate the proximal ends 52, 56 (e.g., proximate the insertion stop surface 16) or the second support edge 72 may be between the proximal ends 52, 56 and the distal ends 54, 58. More specifically, the support 70 may have a length of about, e.g., greater than or equal to 0.5 millimeters, greater than or equal to 1 millimeter, greater than or equal to 5 millimeters, greater than or equal to 10 millimeters, etc. and/or less than or equal to 40 millimeters, less than or equal to 30 millimeters, less than or equal to 25 millimeters, less than or equal to 20 millimeters, less than or equal to 15 millimeters, etc.

The first and second support edges 71, 72 may have various orientations relative to the one or more prongs 20. For example, the first and second support edges 71, 72 may be oriented such that at least one of the first and second support edges 71, 72 are perpendicular to the one or more prongs 20. Specifically, at least one of the first and second support edges 71, 72 may be perpendicular to the sides between which the support 70 extends (e.g., the second side 26 of the first prong 22 and the first side 27 of the second prong 24). In one or more embodiments, for example as shown in FIG. 2A, the first and second support edges 71, 72 may be oriented such that at least one of the first and second support edges 71, 72 are perpendicular to the insertion stop surface 16 (or, e.g., parallel with the cork axis 81). Orienting the first support edge 71 perpendicular to the insertion stop surface 16 may allow the first support edge 71 to be inserted into the cork 80 gradually, and thereby, may reduce resistance when the one or more prongs 20 are inserted into the cork 80.

Further, in one or more embodiments, the first support edge 71 may define a sharp edge similar to, e.g., a blade. A sharp edge of the first support edge 71 may help to cut through a cork 80 when the one or more prongs 20 are inserted into the cork 80. In other words, a sharp edge of the first support edge 71 may reduce the resistance of the one or more prongs 20 when inserted into a cork 80. Additionally, the presence of the one or more prongs 20 around the first support edge 71 may help shield the sharp edge of the first support edge 71 to prevent a sharp edge of the first support edge 71 from being completely exposed. In one or more embodiments, the support 70 may be described as being tapered. For example, the support 70 may be thicker proximate the second support edge 72 than proximate the first support edge 71 such that the support tapers down from the second support edge 72 to the first support edge 71. The sharp edge or tapered edge of the support 70 may allow the first support edge 71 to be inserted into the cork 80 gradually, and thereby, may reduce the resistance when the one or more prongs 20 are inserted into the cork 80.

The one or more prongs 20 may also include one or more protrusions 76 to, e.g., increase the grip of the one or more prongs 20 on the cork 80 after the one or more prongs 20 are inserted into the cork 80. For example, the one or more protrusions 76 may restrict the cork 80 from moving relative to the one or more protrusions 76 (e.g., by providing resistance of the one or more prongs 20 from being withdrawn from the cork 80) when the cork 80 is being extracted from the bore 92 of the bottle 90. In other words, the one or more protrusions 76 may help to provide increased grip of the one or more prongs 20 within the cork 80 and prevent the one or more prongs 20 from sliding out of the cork 80 after the one or more prongs 20 are inserted into the cork 80.

The one or more protrusions 76 may define any shape or extend in any direction that is suitable for assisting the one or more prongs 20 in gripping the cork 80. For example, the one or more protrusions 76 may extend from any of the one or more prongs 20. As shown in FIG. 2A, the one or more protrusions 76 extend from the first prong 22. Specifically, the one or more protrusions 76 extend from the first side 25 of the first prong 22 and towards the body portion 10. In other embodiments, the one or more protrusions 76 may extend from the second prong 24. The one or more protrusions 76 may be contoured such that the one or more prongs 20 may be more easily inserted into the cork 80 and such that the one or more prongs 20 may be restricted (e.g., due to increased resistance) from being pulled out of the cork 80 (e.g., similar to an arrowhead). Additionally, it may be described that the one or more protrusions 76 define a “teeth-like”structure or define a generally triangular shape. The effective height of the one or more protrusions 76 may be defined as extending between about, e.g., greater than or equal to 0.5 millimeters, greater than or equal to 1 millimeter, greater than or equal to 1.5 millimeters, greater than or equal to 2 millimeters, etc. and/or less than or equal to 5 millimeters, less than or equal to 4 millimeters, less than or equal to 3 millimeters, less than or equal to 1.75 millimeters, etc. away from the one or more prongs 20.

As shown in FIG. 2B, the cork extracting apparatus 5 defines a first surface 42 and an opposing second surface 44. The first and second surfaces 42, 44 may each be described as being perpendicular to the insertion stop surface 16. Additionally, in one or more embodiments, the first and second surfaces 42, 44 may be parallel to one another. The cork extracting apparatus 5 may define a thickness 40 between the first surface 42 and the second surface 44. The thickness 40 between the first and second surfaces 42, 44 may be about, e.g., greater than or equal to 0.5 millimeters, greater than or equal to 1 millimeter, greater than or equal to 1.5 millimeters, greater than or equal to 2 millimeters, etc. and/or less than or equal to 5 millimeters, less than or equal to 4 millimeters, less than or equal to 3 millimeters, less than or equal to 1.75 millimeters, etc.

The thickness 40 of the cork extracting apparatus 5 may be consistent across the entire cork extracting apparatus 5 or the thickness 40 may vary at different points of the cork extracting apparatus 5. For example, the body portion 10 and the one or more prongs 20 may define the same or different thicknesses. Specifically, one of the body portion 10 or the one or more prongs 20 may be thicker than the other to provide increased structural rigidity that may not be necessary for the other of the body portion 10 or the one or more prongs 20.

In one or more embodiments, the cork extracting apparatus 5 may be described as lying in a plane (e.g., a plane formed by the page of FIG. 2A). In other words, the body portion 10 and the one or more prongs 20 may both lie substantially in the same plane. The overall profile of the cork extracting apparatus 5 may be minimized with the entirety of the cork extracting apparatus 5 lying in the same plane (e.g., providing a more “smooth” apparatus to prevent catching on surroundings). In other words, the cork extracting apparatus 5 may be more transportable with each of the body portion 10 and the one or more prongs 20 lying in the same plane. In other embodiments, the body portion 10 and the one or more prongs 20 may lie in different planes. For example, in some embodiments, the one or more prongs 20 may lie in a plane that is perpendicular to a plane in which the body portion 10 lies.

The cork extracting apparatus 5 may include a variety of different materials. For example, the cork extracting apparatus 5 may include (e.g., be formed of) one or more materials such as, e.g., stainless steel, aluminum, titanium, 3d printed materials, tool steel, etc. The cork extracting apparatus 5 may include a single material or multiple materials. For example, different portions of the cork extracting apparatus 5 (e.g., the body portion 10 or the one or more prongs 20) may be formed of different or the same materials.

The cork extracting apparatus 5 may be formed through one or more processes. For example, the cork extracting apparatus 5 may be formed through molded processes, die-casting processes, machining, 3d printing, etc. In one or more embodiments, different portions of the cork extracting apparatus 5 may be formed differently than other portions. For example, the body portion 10 may be formed by a first process and the one or more prongs 20 may be formed by a second process. The body portion 10 and the one or more prongs 20 may then be coupled together by a weld, adhesive, a hinge, etc.

In one or more embodiments, the body portion 10 may be described as substantially smooth to avoid catching in pockets or snagging on clothing worn by a user. In other embodiments, the body portion 10 may include rough, jagged, and sharp edges to provide, for example, a cutting tool, a sanding tool, an etching tool, etc. to increase the number of uses of the cork extracting apparatus 5.

A cross-sectional view of the cork extracting apparatus 5 inserted into a cork 80 is illustrated in FIG. 3. The cork 80 may define a top surface 82 and a bottom surface 84 opposing the top surface 82. The bottom surface 84 of the cork 80 may be farther inside the bottle 90 than the top surface 82 of the cork 80 when the cork 80 is positioned in the bore 92 of the bottle 90. In one or more embodiments, the cork 80 may be positioned within the bore 92 of the bottle 90 such that the top surface 82 of the cork 80 may be flush with a lip 91 of the bottle 90 or the top surface 82 of the cork may be farther within the bore 92 of the bottle 90 and offset from the lip 91 of the bottle 90. For example, the top surface 82 of the cork 80 may be positioned less than or equal to 3 millimeters, less than or equal to 2 millimeters, or less than or equal to 1 millimeter from the lip 91 of the bottle 90.

The cork 80 may define a cork axis 81 (may also be described as a bore axis) that extends through both the top surface 82 of the cork 80 and the bottom surface 84 of the cork 80. The cork axis 81 extends substantially through the center of the cork 80. In some embodiments, it may be described that the cork 80 is rotationally symmetrical about the cork axis 81 (e.g., the cork 80 may be cylindrical).

The finger aperture 13 of the body portion 10 may define a centerpoint 11 as shown in FIG. 3. In one or more embodiments, the centerpoint 11 of the finger aperture 13 may be described as being offset from the cork axis 81 when the one or more prongs 20 of the cork extracting apparatus 5 are inserted into the cork 80. The finger aperture centerpoint 11 being offset from the cork axis 81 may provide better leverage (e.g., to turn the body portion 10) to the user to facilitate removal of the cork 80 from the bore 92 of the bottle 90. For example, the finger aperture centerpoint 11 being offset from the cork axis 81 may provide increased leverage force both along the cork axis 81 and about the cork axis 81 when the cork extracting apparatus 5 is attached to the cork 80 and pulled/twisted away from the bottle 90. The increased leverage force may assist in easier extraction of the cork 80 from the bore 92 of the bottle 90.

In other embodiments, the centerpoint 11 and the cork axis 81 may be aligned. Aligning the centerpoint 11 of finger aperture 13 with the cork axis 81 may provide, e.g., a compact design facilitating transport and storage of the cork extracting apparatus 5, a balance of the body portion 10 about the cork axis 81, a balance of the body portion 10 when twisting and pulling the body portion 10, etc.

As described herein, the body portion 10 may also define an insertion stop surface 16. When the cork extracting apparatus 5 is inserted into a cork 80 for removal, the insertion stop surface 16 may be located proximate the cork 80. Specifically, the insertion stop surface 16 may rest against, or be adjacent to, a periphery, or lip 91, of the neck 94 of the bottle 90. More specifically, the insertion stop surface 16 may be configured to contact the bottle 90 proximate the first end region 62 of the body portion 10 upon insertion of the one or more prongs 20 into the cork 80. When the one or more prongs 20 are inserted into a cork 80 for removal, the insertion stop surface 16 may be a distance from the cork 80 of less than or equal to about 1 millimeter, less than or equal to about 2 millimeters, less than or equal to about 3 millimeters, less than or equal to about 4 millimeters, etc.

The distal ends 54, 58 of the one or more prongs 20 may be proximate an inner wall 96 of the bore 92 of the bottle 90 when the one or more prongs 20 are inserted into the cork 80 as illustrated in FIG. 3. Specifically, the distance between one or more prongs 20 and the inner wall 96 of the bore 92 of a bottle 90 (e.g., when the one or more prongs 20 are inserted into the cork 80) may be less than or equal to about 5 millimeters, less than or equal to about 3 millimeters, less than or equal to about 2 millimeter, etc. In one or more embodiments, the distal ends 54, 57 of the one or more prongs 20 may contact the inner wall 96 when the one or more prongs 20 are inserted into the cork 80.

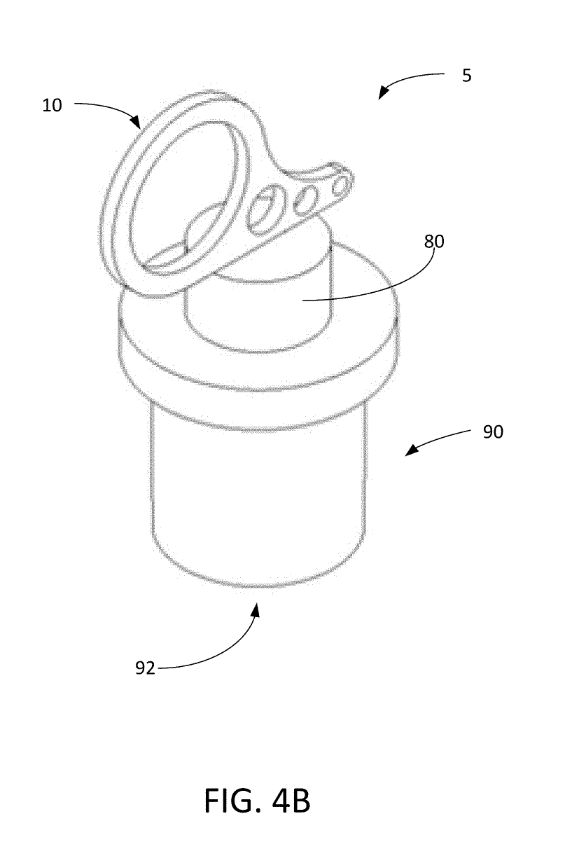

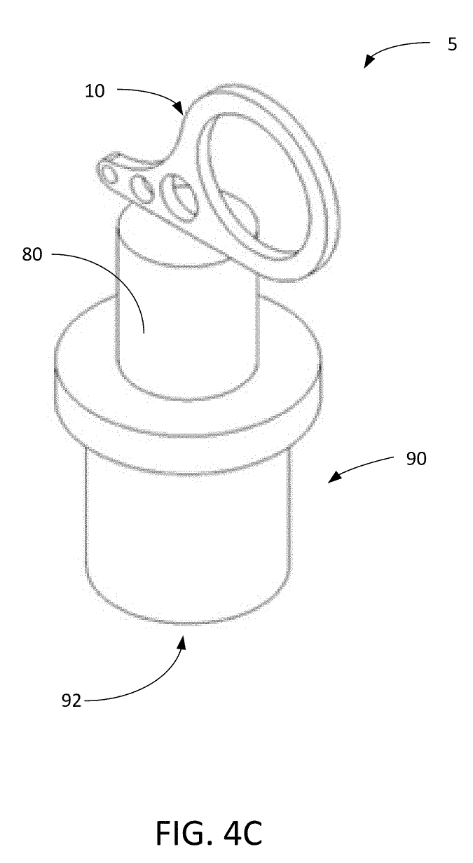

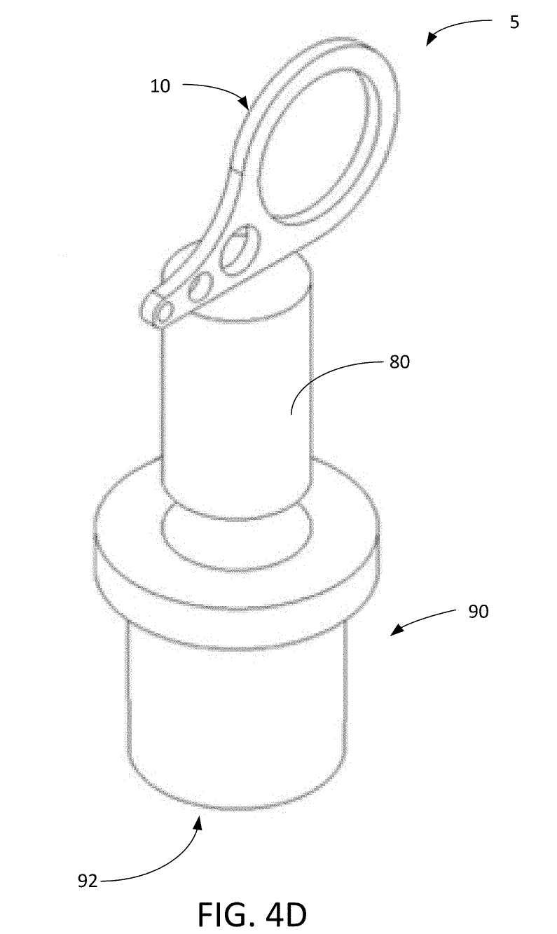

A method of extracting a cork 80 from a bore 92 of a bottle 90 using a cork extracting apparatus 5 is illustrated in FIGS. 4A-4D. For example, one or more prongs 20 of the cork extracting apparatus 5 may be inserted into the cork 80 such that at least a portion of an insertion stop surface 16 may be located proximate the cork 80 as illustrated in FIG. 4A. Further, the method may include rotating a body portion 10 of the cork extracting apparatus 5 and pulling the body portion 10 away from the bore 92 of the bottle 90, moving the cork 80 away from the bottle 90 as depicted in FIG. 4B. As the body portion 10 is further rotated and pulled away from the bore 92 of the bottle, the cork 80 may move farther upwards and away from the bore 92 as illustrated in FIG. 4C. After the cork 80 is extracted from the bore 92 of the bottle, the one or more prongs 20 are still positioned within the cork 80 and the bore 92 of the bottle 90 is no longer obstructed (e.g., with a cork 80) as illustrated in FIG. 4D.

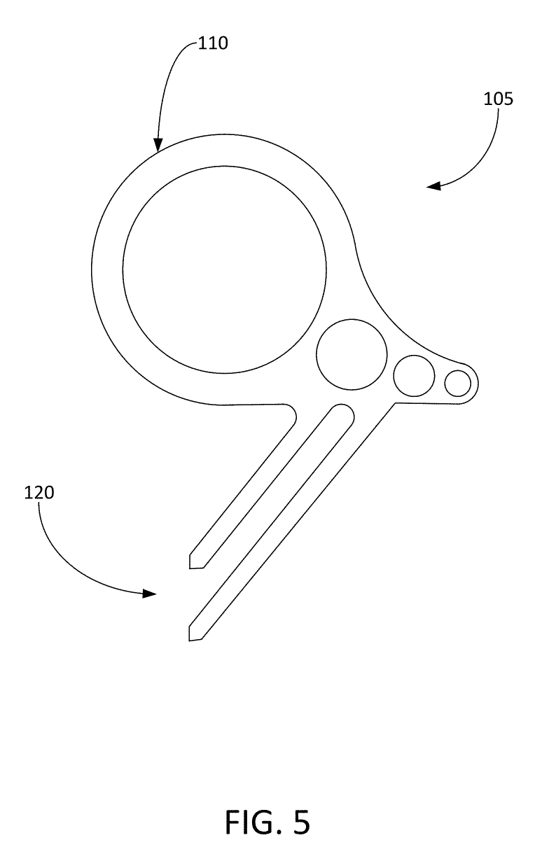

Another exemplary embodiment of the cork extracting apparatus 105 is illustrated in FIG. 5. This exemplary cork extracting apparatus 105 includes a body portion 110 and one or more prongs 120 similar to those described in FIGS. 1-4. The one or more prongs 120 of the cork extracting apparatus 105 illustrated in FIG. 5 do not have a support between the one or more prongs 120 or one or more protrusions (e.g., as illustrated in FIGS. 1-3) Additionally, the cork extracting apparatus 105 illustrated in FIG. 5 may be used in the method described in FIGS. 4A-4D.

This disclosure has been provided with reference to illustrative embodiments and is not meant to be construed in a limiting sense. As described previously, one skilled in the art will recognize that other various illustrative applications may use the techniques as described herein to take advantage of the beneficial characteristics of the system and methods described herein. Various modifications of the illustrative embodiments, as well as additional embodiments of the disclosure, will be apparent upon reference to this description.

What is claimed is:

1. An apparatus for extracting a cork from a bore of a bottle, wherein the apparatus comprises:
a body portion defining an insertion stop surface and one or more grasping features configured to be grasped by a user; and
one or more prongs coupled to the body portion, wherein each of the one or more prongs extend along a prong axis away from the insertion stop surface of the body portion such that the prong axis and the insertion stop surface define an acute angle, wherein the one or more prongs are configured to be inserted into the cork by the user such that at least a portion of the insertion stop surface is located proximate the cork, and wherein, upon insertion, rotation and movement of the body portion away from the bottle by the user extracts the cork from the bore of the bottle.

2. The apparatus of claim 1, wherein the prong axis and the insertion stop surface define an acute angle between 30 degrees and 60 degrees.

3. The apparatus of claim 1, wherein the body portion extends from a first end region to a second end region and the one or more prongs are coupled to the body portion between the first end region and the second end region, wherein the insertion stop surface of the body portion is configured to contact the bottle proximate the first end region upon insertion of the one or more prongs into the cork.

4. The apparatus of claim 1, wherein the one or more prongs comprises a first prong and a second prong, wherein the prong axis of the first prong extends parallel the prong axis of the second prong.

5. The apparatus of claim 4, wherein the second prong extends farther from the insertion stop surface than the first prong.

6. The apparatus of claim 4, wherein the first and second prongs are located at least 1 millimeter from each other.

7. The apparatus of claim 1, wherein the apparatus defines:
a first surface extending perpendicular from the insertion stop surface; and
a second surface extending perpendicular from the insertion stop surface and parallel the first surface,
wherein the apparatus defines a thickness of about 2 millimeters between the first surface and the second surface.

8. The apparatus of claim 1, wherein the one or more grasping features comprise a finger aperture configured to receive a finger of the user.

9. The apparatus of claim 1, wherein the body portion is configured to rotate about a cork axis of the cork to extract the cork from the bore of the bottle, wherein the one or more grasping features comprises a finger aperture configured to receive a finger of the user, wherein a centerpoint of the finger aperture is offset from the cork axis.

10. The apparatus of claim 1, wherein the one or more prongs comprise a support between the one or more prongs, wherein the support extends between a first support edge and a second support edge that is closer to the body portion than the first support edge, and wherein a thickness of the support tapers down from the second support edge to the first support edge.

11. The apparatus of claim 1, wherein the one or more prongs comprise one or more protrusions extending from the one or more prongs.

12. The apparatus of claim 1, wherein each of the one or more prongs extends from a proximal end coupled to the body portion to a distal end configured to be located proximate an inner wall of the bore of the bottle upon insertion of the one or more prongs.

13. An apparatus for extracting a cork from a bore of a bottle, wherein the apparatus comprises:
a first prong extending from a proximal end to a distal end;
a second prong extending from a proximal end to a distal end, wherein the first and second prongs are configured to be inserted into the cork by a user such that at least one of the distal ends of the first and second prongs is located proximate an inner wall of the bore of the bottle; and
a body portion coupled to the proximal ends of the first and second prongs, wherein, upon insertion of the first and second prongs into the cork, the body portion is configured to be grasped, rotated, and pulled away from the bottle by the user to extract the cork from the bore of the bottle.

14. The apparatus of claim 13, wherein the body portion defines an insertion stop surface configured such that at least a portion of the insertion stop surface is located proximate the cork when the first and second prongs are inserted into the cork.

15. The apparatus of claim 14, wherein the proximal ends of the first and second prongs are coupled to the insertion stop surface of the body portion, wherein the first prong extends along a first prong axis from the proximal end to the distal end such that the first prong axis and the insertion stop surface define a first acute angle, and wherein the second prong extends along a second prong axis from the proximal end to the distal end such that the second prong axis and the insertion stop surface define a second acute angle.

16. The apparatus of claim 15, wherein at least one of the first acute angle and second acute angle are between 30 degrees and 60 degrees.

17. The apparatus of claim 15, wherein the first acute angle and the second acute angle are substantially equal.

18. The apparatus of claim 13, wherein the first and second prongs are located at least 1 millimeter from each other.

19. The apparatus of claim 13, wherein the body portion, the first prong, and the second prong lie in a plane.

20. An apparatus for extracting a cork from a bore of a bottle, wherein the apparatus comprises:
a first prong extending from a proximal end to a distal end;
a second prong extending from a proximal end to a distal end, wherein the first and second prongs are configured to be inserted into the cork by a user such that at least one of the distal ends of the first and second prongs is located proximate an inner wall of the bore of the bottle;
a support between the first and second prongs;
one or more protrusions extending from at least one of the first and second prongs; and
a body portion coupled to the proximal ends of the first and second prongs and defining a finger aperture configured to receive a finger of the user, wherein the body portion is configured to rotate about a cork axis of the cork to extract the cork from the bore of the bottle, wherein a centerpoint of the finger aperture is offset from the cork axis,
wherein, upon insertion of the first and second prongs into the cork, the body portion is configured to be grasped, rotated, and pulled away from the bottle by the user to extract the cork from the bore of the bottle.
